(19) United States
(12) Patent Application Publication
(10) Pub. No.: US 2026/0212693 A1
(43) Pub. Date: Jul. 23, 2026

(54) INFORMATION PROCESSING APPARATUS, INFORMATION PROCESSING METHOD, AND COMPUTER PROGRAM PRODUCT

(71) Applicants: KABUSHIKI KAISHA TOSHIBA, Kawasaki-shi Kanagawa (JP); TOSHIBA DIGITAL SOLUTIONS CORPORATION, Kawasaki-shi Kanagawa (JP)

(72) Inventor: Ryohei Tanaka, Kawasaki Kanagawa (JP)

(73) Assignees: KABUSHIKI KAISHA TOSHIBA, Kawasaki-shi Kanagawa (JP); TOSHIBA DIGITAL SOLUTIONS CORPORATION, Kawasaki-shi Kanagawa (JP)

(21) Appl. No.: 19/371,652

(22) Filed: Oct. 28, 2025

(30) Foreign Application Priority Data
Jan. 21, 2025 (JP) 2025-008367

(51) Int. Cl. G06V 30/28

(52) U.S. Cl. CPC G06V 30/287

(57) ABSTRACT

An information processing apparatus includes an extractor, a determiner, and a selector. The extractor extracts, from an image including a plurality of character strings, one or more character string regions including a plurality of character strings written in a direction for each of a plurality of directions. The determiner determines a direction in which a character string included in a connection region is written for each of one or more connection regions, each corresponding to a region in which a plurality of character string regions adjacent to each other is connected. The selector selects, for each of the one or more connection regions, the one or more character string regions extracted in the direction matching the direction determined for the connection region among the one or more character string regions included in the connection region.

### CROSS-REFERENCE TO RELATED APPLICATIONS

This application is based upon and claims the benefit of priority from Japanese Patent Application No. 2025-008367, filed Jan. 21, 2025, the entire contents of which are incorporated herein by reference.

### FIELD

Embodiments described herein relate generally to an information processing apparatus, an information processing method, and a computer program product.

### BACKGROUND

A technique of extracting a region including a character string (character string region) from an input image and recognizing the character string from the extracted character string region is known. The image may include a plurality of character strings written in a plurality of different directions. When targeting an image of mixed character strings written in a plurality of directions, such composing is required as to avoid erroneously extracting a character string region in a different direction from an actual writing direction.

### BRIEF DESCRIPTION OF THE DRAWINGS

FIG. 1 is a diagram illustrating a flow of a function of extracting a character string region according to a comparative example;

FIG. 2 is a diagram illustrating an example in which a character string region is erroneously extracted;

FIG. 3 is a block diagram of an information processing apparatus according to an embodiment;

FIG. 4 is a flowchart illustrating an example of extraction processing according to the embodiment;

FIG. 5 is a diagram illustrating a specific example of the extraction processing;

FIG. 6 is a diagram illustrating an example of extraction of a connection region and determination of a direction;

FIG. 7 is a diagram illustrating an example of extraction of a connection region according to a first modification;

FIG. 8 is a diagram illustrating an example of extraction of a character string region according to a second modification;

FIG. 9 is a diagram illustrating an example of a display screen applicable to the embodiment and the modifications; and

FIG. 10 is a hardware configuration diagram of the information processing apparatus according to the embodiment.

### DETAILED DESCRIPTION

An object of the present disclosure is to provide an information processing apparatus, an information processing method, and a computer program product capable of extracting a region including a character string with higher accuracy from a mixed image of a plurality of character strings written in a plurality of directions.

According to an embodiment, an information processing apparatus includes one or more hardware processors configured to function as an extractor, a determiner, and a selector. The extractor extracts, from an image including a plurality of character strings, one or more character string regions including a plurality of character strings written in a direction for each of a plurality of directions. The determiner determines a direction in which a character string included in a connection region is written for each of one or more connection regions. Where each connection region corresponds to a region in which a plurality of character string regions adjacent to each other is connected. The selector selects for each of the one or more connection regions, the one or more character string regions extracted in the direction matching the direction determined for the connection region among the one or more character string regions included in the connection region.

Hereinafter, a preferred embodiment of an information processing apparatus according to the present disclosure is described in detail with reference to the accompanying drawings. The present disclosure is not limited to the following embodiments.

A function of extracting a character string region from an image is used as, for example, prior processing of a character recognition function which recognizes a character string written in the given region. The extracted character string region is not limited to being used in the character recognition function and may be used in any other functions. For example, the extracted character string region may be used in the following functions.
A function of determining a language of a character string in a character string region
A function of determining a writer identification of a character string in a character string region (function of specifying an individual)
A function of distributing a plurality of character string regions and executing various types of processing

Examples of a technique for extracting a character string region from an image include the following techniques.
Extraction of a character string region by semantic segmentation
Extraction of a character string region by a density histogram
Extraction of a character string region by detecting a bounding box

In any of the techniques, a character string region may not be extracted in a correct direction from an image including a plurality of character strings written in a plurality of different directions. Hereinafter, an example of a situation in which the character string region is not correctly extracted is described.

Hereinafter, an example of extracting a character string region by semantic segmentation (comparative example) is described. Hereinafter, an example in which the different directions are a horizontal direction (left-right direction of image) and a vertical direction (up-down direction of image) is described as an example. The directions are not limited to the horizontal direction and the vertical direction and may be any other directions. For example, the directions may include an oblique direction and a curved direction (such as a circumferential direction).

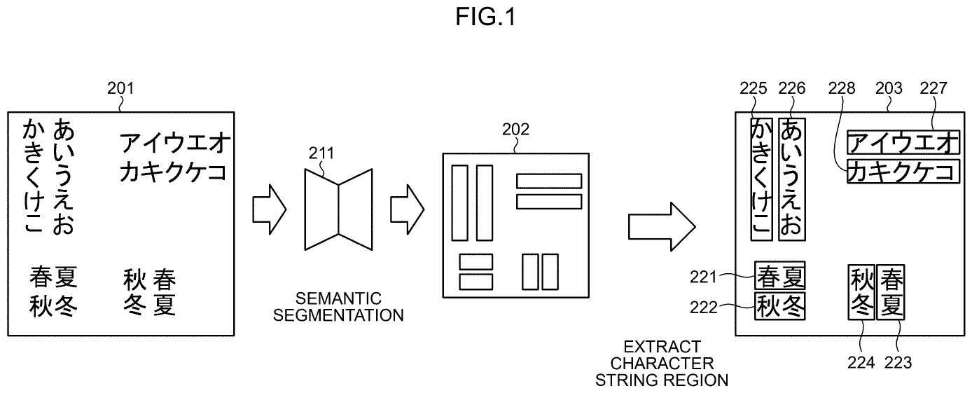

FIG. 1 is a diagram illustrating a flow of the function of extracting a character string region by the semantic segmentation according to the comparative example.

When an image 201 is input, a model 211 executes the semantic segmentation on the image 201 and outputs a processing result 202 of the semantic segmentation. For example, the model 211 is a trained (learned) model that outputs classification information on a plurality of partial regions included in an input image for each of the plurality of partial regions. The model may be a model having any structure and is, for example, a neural network model.

The partial region is, for example, a pixel or a region including a plurality of pixels (such as superpixels). The classification information is, for example, information indicating that the partial region is a region not corresponding to a character string or a region corresponding to a character string. For example, the classification information may have the following values.
A partial region that does not correspond to a character string: 0
A partial region that corresponds to a character string: 1

In the example of FIG. 1, a rectangle in the processing result 202 is a partial region that corresponds to a character string (a value of the classification information is 1). Next, a region obtained by connecting a plurality of adjacent partial regions among a plurality of partial regions is extracted as a character string region. An extraction result 203 including eight character string regions 221 to 228 is output for the image 201 of FIG. 1. The character string regions 221 to 228 correspond to the following Japanese character strings.
The character string region 221: Former two Kanji characters (“ [symbol] ”/“spring, summer”) among four Kanji characters meaning “ [symbol] ”/“spring, summer, autumn, and winter” written horizontally
The character string region 222: Latter two Kanji characters (“ [symbol] ”/“autumn, winter”) among four Kanji characters meaning “ [symbol] ”/“spring, summer, autumn, and winter” written horizontally
The character string region 223: Former two Kanji characters (“ [symbol] ”/“spring, summer”) among four Kanji characters meaning “ [symbol] ”/“spring, summer, autumn, and winter” written vertically
The character string region 224: Latter two Kanji characters (“ [symbol] ”/“autumn, winter”) among four Kanji characters meaning “ [symbol] ”/“spring, summer, autumn, and winter” written vertically
The character string region 225: Five hiragana characters written vertically (“ [symbol] ”/“ka, ki, ku, ke, ko”)
The character string region 226: Five hiragana characters written vertically (“ [symbol] ”/“a, i, u, e, o”)
The character string region 227: Five katakana characters written horizontally (“ [symbol] ”/“a, i, u, e, o”)
The character string region 228: Five katakana characters written horizontally (“ [symbol] ”/“ka, ki, ku, ke, ko”)

Thereafter, a writing direction of the characters in each of the character string regions is determined. The writing direction is determined by, for example, the following determination methods.
A method of determining using an aspect ratio of a character string region
A method of executing character recognition for each of a plurality of writing directions (for example, the horizontal direction and the vertical direction) and determining a direction in which an obtained recognition result is more likely as the writing direction
A method of using a trained (learned) determination device (determination model) that receives input of a character string region and outputs a writing direction

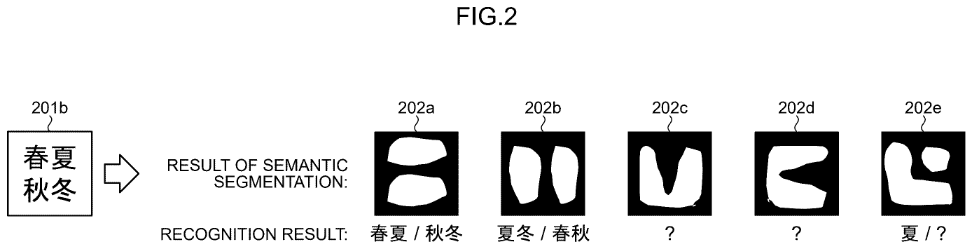

FIG. 1 illustrates an example in which the processing result 202 of ideal semantic segmentation is obtained and the character string region is correctly extracted. FIG. 2 is a diagram illustrating an example in which the character string region is erroneously extracted.

In FIG. 2, an example in which an image 201b including four Kanji characters meaning “ [symbol] ”/“spring, summer, autumn, and winter” written horizontally in two lines is input is described. Processing results 202a to 202e represent example results of the semantic segmentation that may be output for the image 201b. Among the processing results 202a to 202e, a black region represents a partial region that does not correspond to a character string (value of classification information=0), and a white region represents a partial region that corresponds to a character string (value of classification information=1).

The processing result 202a corresponds to a result of correct semantic segmentation. For example, two character string regions in the horizontal direction are extracted from the processing result 202a. When character recognition is executed on the two extracted character string regions, a correct recognition result is obtained as illustrated below the processing result 202a.

The processing result 202b corresponds to a result of semantic segmentation in which the classification information is set so that a character string region in an incorrect direction is extracted. For example, two character string regions in the vertical direction are extracted from the processing result 202b. When the character recognition is executed on the extracted two character string regions, the character strings as a correct recognition result are obtained, but as illustrated below the processing result 202b, orders of the obtained character strings are incorrect.

The processing results 202c to 202e indicate other examples of the result of semantic segmentation in which classification information is set so that an incorrect character string region is extracted. The processing results 202c to 202e correspond to processing results from which a mixed region of character strings in the horizontal direction and the vertical direction can be extracted as the character string region. Even when character recognition is executed on such character string regions, generally, a correct recognition result cannot be obtained. A recognition result “?” represents any character and indicates that the recognition result is incorrect.

As described above, in the comparative example, a character string region may not be appropriately extracted from a mixed image of character strings in a plurality of writing directions.

The information processing apparatus according to the embodiment has a function for solving the above-described problem in the comparative example. For example, the information processing apparatus according to the embodiment extracts character string regions including character strings written in a direction for each of a plurality of directions and determines a writing direction of character strings included in a connection region corresponding to a region obtained by connecting a plurality of character string regions. Then, the information processing apparatus according to the embodiment selects a character string region extracted in a direction matching the determined direction among the character string regions included in the connection region. As a result, a character string region can be extracted with higher accuracy from a mixed image of a plurality of character strings written in a plurality of different directions.

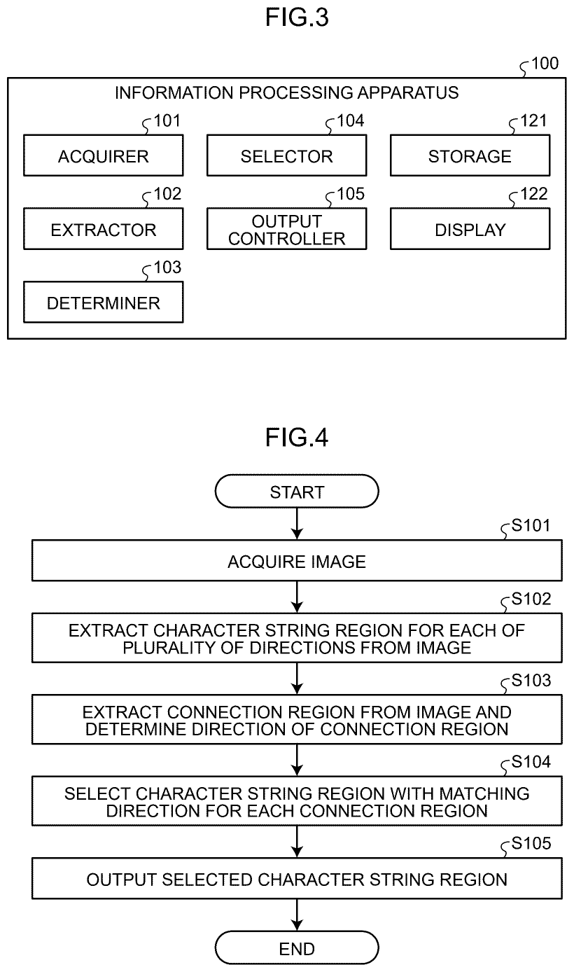

FIG. 3 is a block diagram illustrating an example of a configuration of an information processing apparatus 100 according to the embodiment. As illustrated in FIG. 3, the information processing apparatus 100 includes an acquirer 101, an extractor 102, a determiner 103, a selector 104, an output controller 105, storage 121, and a display 122.

The acquirer 101 acquires various types of information used in the information processing apparatus 100. For example, the acquirer 101 acquires an image from which a character string region is to be extracted. The image to be processed is an image including a plurality of character strings. An acquisition method of information used by the acquirer 101 may be any method, and for example, a method of receiving information from an external device via a network, a method of reading information from a storage medium, or the like can be applied.

The extractor 102 extracts one or more character string regions including a plurality of character strings written in a direction for each of a plurality of directions from an image including the plurality of character strings. For example, the extractor 102 extracts the one or more character string regions by executing semantic segmentation of outputting classification information for each of the plurality of directions and for each of a plurality of partial regions (pixels, superpixels, and the like) included in the image.

Hereinafter, an example in which the directions are the horizontal direction and the vertical direction is described. The same procedure can also be applied to an example in which other directions are included in the plurality of directions.

For example, the extractor 102 executes semantic segmentation on the input image by using a trained (learned) model that outputs a processing result of the semantic segmentation in which the writing direction of the character string is the horizontal direction and a processing result of the semantic segmentation in which the writing direction of the character string is the vertical direction. The extractor 102 extracts a region obtained by connecting a plurality of adjacent partial regions among the plurality of partial regions as a character string region.

The model may be divided into a model M1 that outputs the processing result of the semantic segmentation in which the writing direction is the horizontal direction and a model M2 that outputs the processing result of the semantic segmentation in which the writing direction is the vertical direction, or the model may be one model in which the model M1 and the model M2 are integrated.

The model M1 is, for example, a model that outputs classification information indicating a partial region corresponding to a character string in the horizontal direction (for example, value=1) or other partial regions (for example, value=0). The model M2 is, for example, a model that outputs classification information indicating a partial region corresponding to a character string in the vertical direction (for example, value=1) or other partial regions (for example, value=0). That is, the models M1 and M2 are models that perform classification into two classes.

The classification information may be information indicating a degree of certainty (probability) for each class. Here, the class having the largest degree of certainty is used as the classification result.

The extractor 102 is not limited to a configuration of extracting a character string region by the semantic segmentation. For example, instance segmentation may be used instead of the semantic segmentation. The extractor 102 may extract one or more character string regions by applying either bounding box detection or a vision transformer. The extractor 102 only needs to be configured to extract one or more character string regions including a plurality of character strings written in a direction for each of the plurality of directions (for example, horizontal direction and vertical direction).

The extractor 102 may deform an image in a direction and extract one or more character string regions by using the deformed image for each of a plurality of directions. For example, when extracting a character string region including a character string written in the horizontal direction, the extractor 102 may be configured to use an image reduced in the horizontal direction. As a result, the processing in the extractor 102 can be sped up. Since a processing result (character string region) based on the reduced image is output, next processing that uses the processing result can be sped up.

For each of one or more connection regions included in an image, the determiner 103 determines a writing direction of a character string included in the connection region. The connection region is a region included in the image and corresponds to a region in which adjacent character string regions are connected.

For example, the determiner 103 executes the semantic segmentation on the input image by using the trained (learned) model M3 that outputs classification information for each of a plurality of partial regions included in an image, where the classification information indicates the region not corresponding to a character string, or the region corresponding to a character string written in a direction among the plurality of directions.

A model M3 is, for example, a model that outputs classification information having the following values. That is, the model M3 is a model that performs classification into three classes. The classification information may be information indicating a degree of certainty (probability) for each class.
A partial region that does not correspond to a character string: 0
A partial region that corresponds to a character string in the horizontal direction: 1
A partial region that corresponds to a character string in the vertical direction: 2

The model M3 may be integrated with at least one of the model M1 and the model M2 used by the extractor 102.

The determiner 103 connects, among the plurality of partial regions, partial regions for which the classification information indicating a writing direction of the character string (value of 1 or 2) is output and which are adjacent to each other, and generates one or more connection regions. Then, the determiner 103 determines the writing direction of the character string included in the connection region for each of the generated one or more connection regions. The determiner 103 outputs the generated one or more connection regions and the direction determined for each connection region as processing results.

The determination method of the connection region by the determiner 103 may be any method. For example, the determiner 103 determines that, based on the values of the classification information of the plurality of partial regions included in the connected region, a direction indicated by a value of which the number of partial regions set as the value is larger than other values is the direction of the connection region.

The determiner 103 may use the degree of priority designated for each of the plurality of directions and determine a direction while prioritizing a direction designated with a higher degree of priority than other directions.

For example, a weight according to the degree of priority for each direction may be given to each number. When the degree of priority in the horizontal direction is higher than the degree of priority in the vertical direction, the number of partial regions set as the value of the horizontal direction is multiplied by a weight larger than that of the vertical direction and may be compared with the number of partial regions set as the value of the horizontal direction. The degree of priority is designated, for example, by a user who operates a screen. That is, a setting unit that allows the user to set the degree of priority may be provided. For example, when an image determined to include a large number of character strings in the vertical direction is to be processed, the user designates to prioritize the vertical direction. By such a function, determination accuracy of direction can be improved.

A configuration in which the degree of priority is set for each type of the image so that the user designates a type of the image may be adopted. For example, for a type that includes many character strings written vertically such as an image of a Japanese newspaper, the degree of priority indicating that the vertical direction is prioritized may be set in advance in the storage 121 or the like described below.

When the classification information indicating the degree of certainty (probability) for each class is used, the classification result may be determined by the degree of certainty to which a weight according to the degree of priority is applied. For example, it is assumed that the degree of certainty for a partial region corresponding to a character string in the horizontal direction is 0.6, and the degree of certainty for a partial region corresponding to a character string in the vertical direction is 0.4. It is assumed that the degree of priority prioritizing the vertical direction is designated, and a value of a weight corresponding to the degree of priority is 2. The determiner 103 obtains a value of 0.8 by multiplying 0.4 by the weight value of 2 and compares 0.8 with 0.6, thereby determining that the classification result of the partial region is in the vertical direction.

The determiner 103 may determine a direction by using a character recognition result for each of the one or more connection regions. For example, the determiner 103 executes character recognition assuming that the connection region is in the horizontal direction and character recognition assuming that the connection region is in the vertical direction. The determiner 103 determines a direction for which an obtained recognition result is more likely as the writing direction of the character string of the connection region.

The determiner 103 is not limited to a configuration of executing the extraction of connection region and the determination of direction by the semantic segmentation. For example, instance segmentation may be used instead of the semantic segmentation. The determiner 103 may execute the extraction of connection region and the determination of direction by applying any one of bounding box detection and a vision transformer.

The determiner 103 may determine the direction of the connection region by using an enlarged or reduced image. The determiner 103 may output an enlarged or reduced connection region. As a result, it is possible to improve determination accuracy by expanding the field of view, reducing an amount of calculation (increasing a speed of calculation), and the like.

The selector 104 uses the processing result of the determiner 103 and selects a character string region in a direction among the character string regions in the plurality of directions extracted by the extractor 102. For example, the selector 104 selects one or more character string regions extracted in a direction matching the direction determined for the connection region for each of the one or more connection regions among the one or more character string regions included in the connection region.

The output controller 105 controls output of various types of information used in the information processing apparatus 100. For example, the output controller 105 outputs information indicating the character string region selected by the selector 104. The information output method may be any method, and for example, a method of displaying on the display 122, a method of transmitting information to an external device via a network, and the like can be applied.

At least a part of the above-described each unit (the acquirer 101, the extractor 102, the determiner 103, the selector 104, and the output controller 105) may be implemented by one or more processing units. The above-described each unit is implemented by, for example, one or a plurality of processors. For example, the above-described each unit may be implemented by causing a processor such as a central processing unit (CPU) and a graphics processing unit (GPU) to execute a program, that is, by software. The above-described each unit may be implemented by a processor such as a dedicated integrated circuit (IC), that is, by hardware. The above-described each unit may be implemented using a combination of software and hardware. When a plurality of processors is used, each processor may implement one unit or may implement two or a plurality of units.

The storage 121 stores various types of information used in the information processing apparatus. For example, the storage 121 stores the image acquired by the acquirer 101 and the processing result by each unit. The storage 121 can be configured by any generally used storage medium such as a flash memory, a memory card, a random access memory (RAM), a hard disk drive (HDD), and an optical disk.

The display 122 is a display device for displaying various types of information and is implemented by, for example, a liquid crystal display and a touch panel.

The information processing apparatus 100 may be physically configured by one apparatus or may be physically configured by a plurality of apparatuses. For example, the information processing apparatus 100 may be constructed on a cloud environment. Each unit of the information processing apparatus 100 may be provided to be dispersed in a plurality of apparatuses.

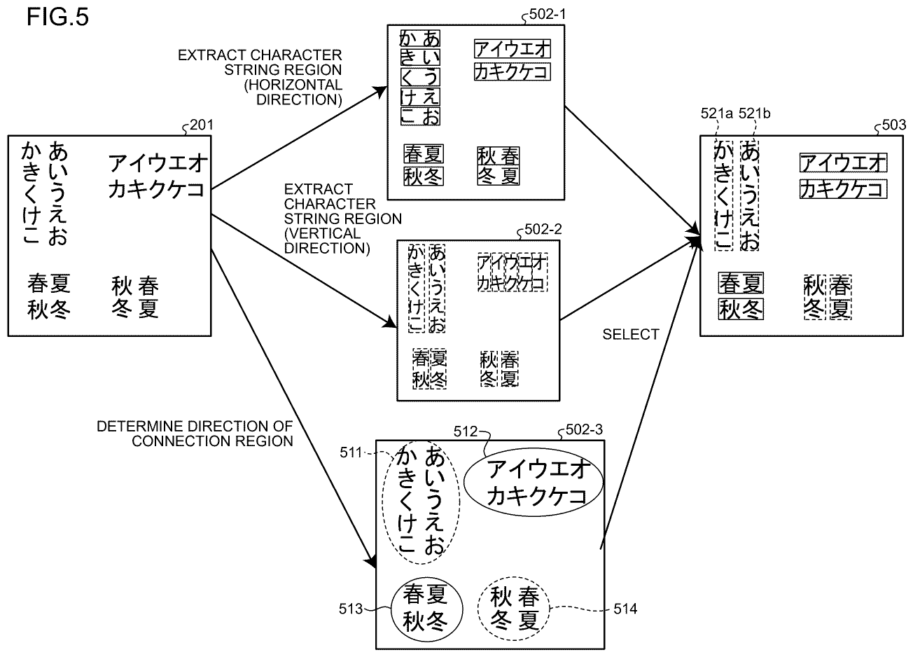

Next, extraction processing of a character string region by the information processing apparatus 100 according to the embodiment is described. FIG. 4 is a flowchart illustrating an example of the extraction processing according to the embodiment. FIG. 5 is a diagram illustrating a specific example of the extraction processing.

The acquirer 101 acquires an image from which a character string region is to be extracted (step S101). In the example of FIG. 5, the acquirer 101 acquires the image 201.

The extractor 102 extracts a character string region for each of a plurality of directions from the image 201 (step S102). In the example of FIG. 5, the extractor 102 outputs an extraction result 502-1 of the character string region in the horizontal direction based on the model M1 and an extraction result 502-2 of the character string region in the vertical direction based on the model M2.

The determiner 103 extracts a connection region from the image 201 and determines a direction of the extracted connection region (step S103). In the example of FIG. 5, the determiner 103 outputs a processing result 502-3 including four connection regions 511 to 514. Two connection regions 512 and 513 surrounded by solid lines represent connection regions determined to be in the horizontal direction, and other two connection regions 511 and 514 represent connection regions determined to be in the vertical direction. In FIG. 5, the connection regions are represented in an elliptical shape, but the connection regions are not limited to an elliptical shape and may be represented in any other shape.

The selector 104 selects a character string region in a direction matching the direction determined for the connection region among the character string regions included in the connection region and extracted by the extractor 102 for each of the extracted connection regions (step S104). An example of FIG. 5 is described. For example, the connection region 511 is determined to be in the vertical direction. Therefore, the selector 104 selects two character string regions 521a and 521b included in the extraction result 502-2 of the character string region in the vertical direction for the connection region 511. Similarly, the selector 104 extracts character string regions for each of the rest of connection regions 512 to 514 and outputs a selection result 503 including the extracted character string regions.

The output controller 105 outputs the selected character string region (step S105) and ends the extraction processing. The output character string region can be used for, for example, character recognition processing.

In the present embodiment, even from a mixed image of character strings in a plurality of writing directions, the writing direction can be determined in units of a connection region corresponding to a region in which character string regions are connected. As a result, it is possible to avoid extraction of a character string region in which regions in different writing directions are connected, for example, as in the processing results 202c to 202e in FIG. 2.

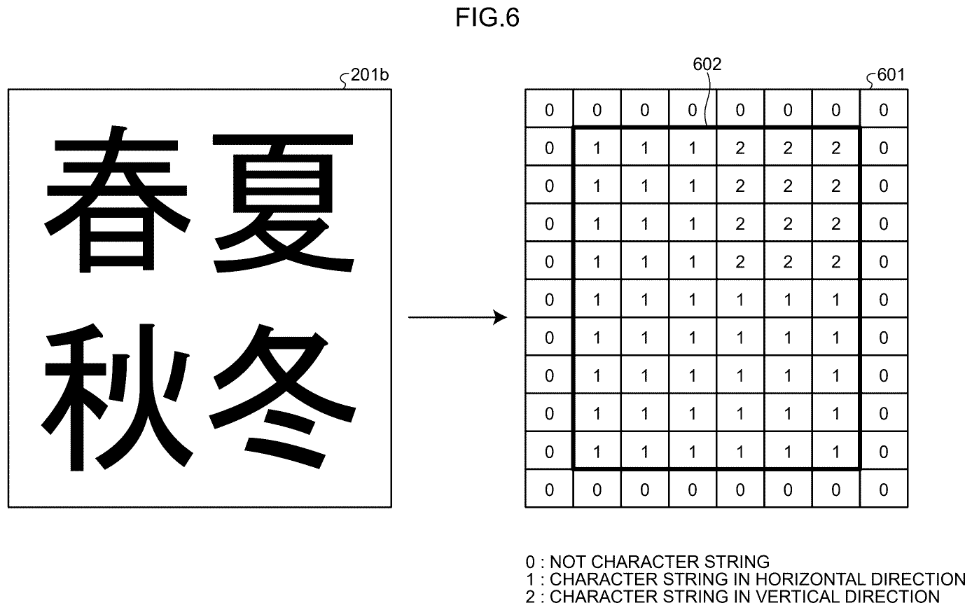

Next, an example of the extraction of the connection region and the determination of the direction executed in the extraction processing is described. FIG. 6 is a diagram illustrating an example of the extraction of the connection region and the determination of the direction. Similarly to FIG. 2, FIG. 6 illustrates an example in which a connection region is extracted from the image 201b including four Kanji characters written horizontally in two lines.

The determiner 103 executes the semantic segmentation on the image 201b by using the model M3 and outputs a processing result 601. Rectangles in the processing result 601 correspond to partial regions, and numerical values represent values of the classification information. It is desirable that the values of the classification information are all set to a value of 1 indicating that the character string is in the horizontal direction for the partial regions corresponding to character strings. In the processing result 601, with respect to a plurality of partial regions corresponding to the second Kanji character (“ [symbol] ”/“summer”), a value of 2 indicating that the character string in the vertical direction is erroneously set.

The determiner 103 generates a connection region by connecting a plurality of partial regions for which the classification information indicating a writing direction of the character string (value of 1 or value of 2) is output and that are adjacent to each other. In the example of FIG. 6, one connection region 602 corresponding to a central portion of the image 201b is generated.

The determiner 103 determines the direction of the connection region. In the example of FIG. 6, 52 that is the number of partial regions for which the value of 1 is set is larger than 12 that is the number of partial regions for which the value of 2 is set among the values of the classification information of the plurality of partial regions included in the connection region. Therefore, the determiner 103 determines the horizontal direction indicated by the value of 1 as the direction of the connection region.

### First Modification

In the above embodiment, the connection region is generated (extracted) by the determiner 103 independently of the extraction of the character string region by the extractor 102 using the model M1, the model M2, and the like. In the first modification, an example in which the connection region is generated (extracted) using the extraction result of the character string region by the extractor 102 is described.

In the present modification, the determiner 103 integrates the plurality of pieces of classification information for each of the plurality of directions output by the semantic segmentation by the extractor 102. Then, the determiner 103 uses the integrated classification information and generates one or more connection regions each including a plurality of partial regions for which classification information indicating that the partial region corresponds to a character string is output.

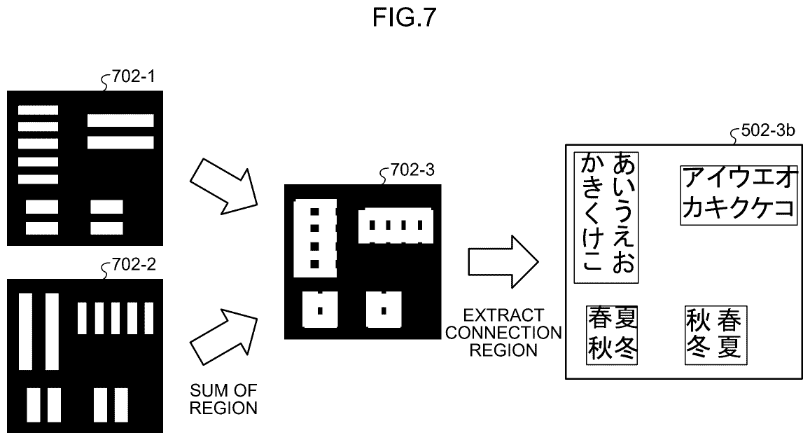

FIG. 7 is a diagram illustrating an example of the extraction of the connection region according to the present modification. Classification information 702-1 corresponds to a processing result of the semantic segmentation by the model M1. Classification information 702-2 corresponds to a processing result of the semantic segmentation by the model M2. Classification information 702-3 corresponds to classification information obtained by integrating the classification information 702-1 and the classification information 702-2. Integration refers to, for example, obtaining a sum of two pieces of classification information.

The determiner 103 generates one or more connection regions by using the classification information 702-3. For example, the determiner 103 generates a region surrounding the partial regions of which the value of the classification information 702-3 is other than 0 as the connection region. In the example of FIG. 7, the determiner 103 outputs a processing result 502-3b including four connection regions.

### Second Modification

In the above embodiment, the model M1 and the model M2 that output the processing result of the semantic segmentation in which the writing direction is one of the horizontal direction and the vertical direction are used. In the training (learning) of the model M1 and the model M2, use of training data that trains (teaches) the corresponding direction is required. In general, it is not easy to provide annotation (teaching) in different writing directions. For example, preparation of training data indicating that the character string is in the horizontal direction is required so that the character string is determined to be in the horizontal direction by the model M1 even when the character string is actually in the vertical direction.

Therefore, in the second modification, an example of configuring a model so that training data can be more easily prepared is described.

In the present modification, the extractor 102 further uses a model MA that executes the semantic segmentation in units of a character. The model MA is a model (first model) that receives input of an image and outputs a region of one or more characters included in the image.

The extractor 102 extracts one or more character string regions for each of the plurality of directions by a model MB (second model) that receives input of a region of one or more characters extracted by the model MA and outputs one or more character string regions. The model MB includes, for example, a model M1′ that receives input of the output of the model MA (result of semantic segmentation in units of character) and outputs a processing result of the semantic segmentation in which the writing direction is in the horizontal direction and a model M2′ that outputs a processing result of semantic segmentation in which the writing direction is in the vertical direction.

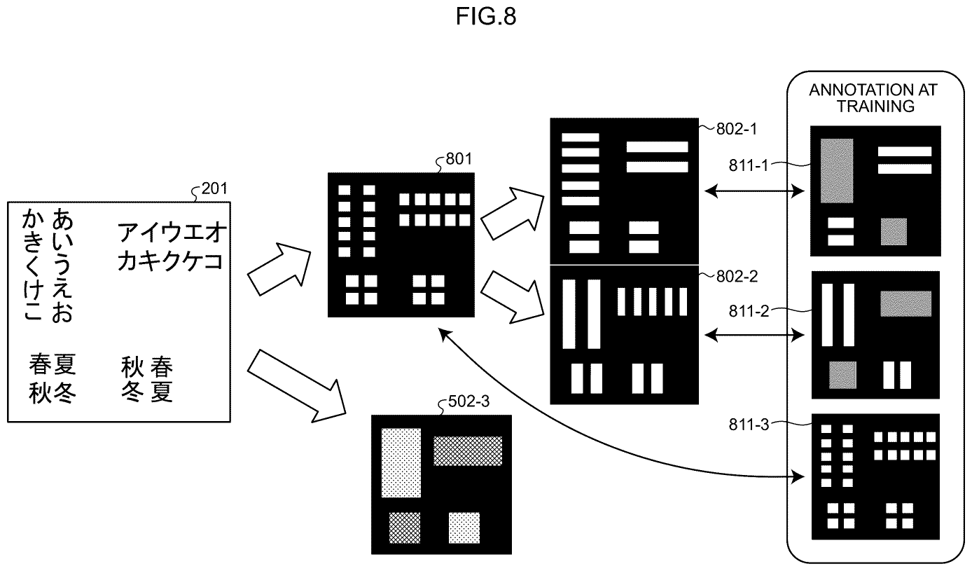

FIG. 8 is a diagram illustrating an example of the extraction of the character string region according to the present modification. Classification information 801 corresponds to a processing result of the semantic segmentation by the model MA. Classification information 802-1 corresponds to a processing result of the semantic segmentation by the model M1′. Classification information 802-2 corresponds to a processing result of the semantic segmentation by the model M2′.

Training data 811-1, 811-2, and 811-3 are used in training of each of the model M1′, the model M2′, and the model MA.

The training data 811-1 is training data for the character string region which is written in the horizontal direction. The training data 811-2 is training data for the character string region which is written in the vertical direction. The training data 811-3 is training data for the region in units of a character.

A gray region in the training data 811-1 and the training data 811-2 represents a region designated as a region for which it is not necessary to calculate a difference from correct answer data in training. As described above, originally, the training data 811-1 does not need to include training data for determining the character string included in the character string region in the vertical direction as the character string in the horizontal direction. Originally, the training data 811-2 does not need to include training data for determining the character string included in the character string region in the horizontal direction as the character string in the vertical direction. Therefore, it is easy to prepare the training data 811-1 and the training data 811-2. It is not difficult to prepare training data for a region in units of a character such as the training data 811-3.

The model MA and the model MB (model M1′ and model M2′) are trained (learned) such that a difference between the output of the model MA and the training data 811-3 corresponding to correct answer data (first correct answer data) and a difference between the output of the model MB and the training data 811-1 and the training data 811-2 corresponding to correct answer data (second correct answer data) become small.

### Example of Screen

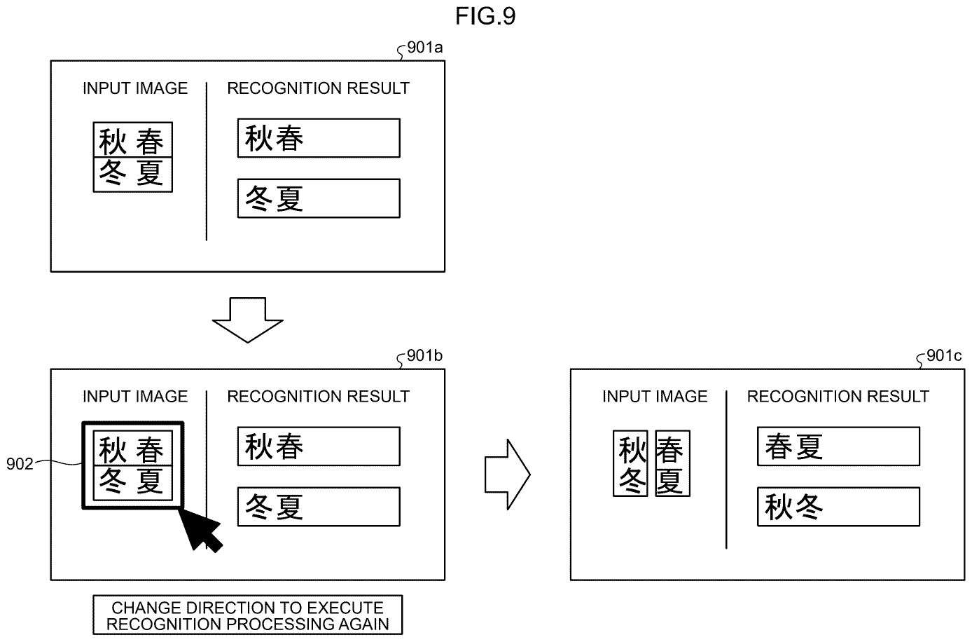

FIG. 9 is a diagram illustrating an example of a display screen applicable to the embodiment and the modifications. For example, the output controller 105 outputs a display screen 901a for receiving a change in the direction of selected one or more character string regions to the display 122. The display screen 901a includes an input image and a recognition result. The recognition result represents a result of executing character recognition on character string regions extracted from the input image. Two rectangular frames indicating the extracted character string regions are illustrated on the input image. On the display screen 901a, a character string region in the horizontal direction including character strings that are actually written vertically but are erroneously determined to be written horizontally is extracted.

A display screen 901b is a screen indicating how a user or the like designates the change of the direction of the character string region. For example, the user designates a region 902 of which the direction is to be changed and changes the direction of the character string region included in the region 902 whereby the recognition processing is executed again (to execute the recognition processing again) for the character string region included in the region 902 in the changed direction. For example, when the change in the direction is received via the display screen 901b, the selector 104 selects one or more character string regions extracted in the changed direction.

In the example of the display screen 901b, change from the horizontal direction to the vertical direction is designated. The selector 104 assumes that the determination result of the direction of the connection region is changed from the horizontal direction to the vertical direction, and newly selects one or more character string regions extracted in the vertical direction indicated by the changed determination result. Then, the character recognition is executed again for the selected character string regions. A display screen 901c is an example of a screen including the character string regions after the direction is changed and a result (recognition result) of the character recognition for the character string regions.

Since the character string regions in the vertical direction are already extracted, the character string regions do not need to be extracted again when the change of the direction is designated. That is, processing such as the character recognition can be executed at high speed when the direction is changed.

As described above, the information processing apparatus according to the embodiment can extract a region including character strings with higher accuracy from a mixed image of a plurality of character strings written in a plurality of different directions.

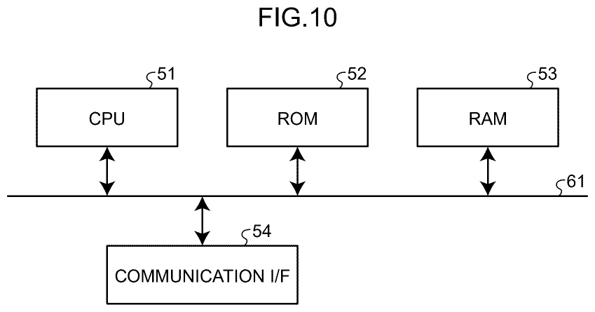

Next, a hardware configuration of the information processing apparatus according to the embodiment is described with reference to FIG. 10. FIG. 10 is an explanatory diagram illustrating a hardware configuration example of the information processing apparatus according to the embodiment.

The information processing apparatus according to the embodiment includes a control device such as a central processing unit (CPU) 51, a storage device such as a read only memory (ROM) 52 and a random access memory (RAM) 53, a communication I/F 54 connected to a network for communication, and a bus 61 that connects the units to each other.

A program executed by the information processing apparatus according to the embodiment is provided by being incorporated in the ROM 52 or the like in advance.

The program executed by the information processing apparatus according to the embodiment may be provided as a computer program product recorded as a file in an installable or executable format in a computer-readable recording medium such as a compact disk read only memory (CD-ROM), a flexible disk (FD), a compact disk recordable (CD-R), or a digital versatile disk (DVD).

The program executed by the information processing apparatus according to the embodiment may be stored in a computer connected to a network such as the Internet and provided by being downloaded via the network. The program executed by the information processing apparatus according to the embodiment may be configured to be provided or distributed via a network such as the Internet.

The program executed by the information processing apparatus according to the embodiment may cause a computer to function as each unit of the information processing apparatus described above. In the computer, the CPU 51 may read the program from a computer-readable storage medium onto a main storage device and execute the program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
one or more hardware processors configured to function as:
an extractor that extracts, from an image including a plurality of character strings, one or more character string regions including a plurality of character strings written in a direction for each of a plurality of directions;
a determiner that determines a direction in which a character string included in a connection region is written for each of one or more connection regions, each corresponding to a region in which a plurality of character string regions adjacent to each other is connected; and
a selector that selects for each of the one or more connection regions, the one or more character string regions extracted in the direction matching the direction determined for the connection region among the one or more character string regions included in the connection region.

2. The information processing apparatus according to claim 1, wherein
the determiner
outputs, for each of a plurality of partial regions included in the image, classification information indicating a region not corresponding to a character string or which direction among the plurality of directions a character string is written when the region corresponds to the character string,
generates, among the plurality of partial regions, the one or more connection regions by connecting the plurality of character string regions adjacent to each other for which the classification information indicating the direction in which the character string is written is output, and
determines the direction in which the character string included in the connection region is written for each of the one or more connection regions generated.

3. The information processing apparatus according to claim 1, wherein
the extractor
extracts the one or more character string regions by outputting classification information indicating a region corresponding to a character string written in the direction or a region not corresponding to the character string written in the direction for each of the plurality of directions and for each of a plurality of partial regions included in the image, and
the determiner
integrates a plurality of pieces of classification information output for each of the plurality of directions and generates the one or more connection regions each including a plurality of partial regions for which the classification information indicative of a region corresponding to a character string is output, and
determines the direction in which the character string included in the connection region is written for each of the one or more connection regions generated.

4. The information processing apparatus according to claim 1, wherein
the extractor
extracts, by using a first model receiving input of the image and outputting a region of one or more characters included in the image, the region of the one or more characters, and
extracts, by using a second model receiving input of the extracted region of the one or more characters and outputting the one or more character string regions, the one or more character string regions for each of the plurality of directions.

5. The information processing apparatus according to claim 4, wherein
the first model and the second model are trained such that a difference between output of the first model and first correct answer data and a difference between output of the second model and second correct answer data become small.

6. The information processing apparatus according to claim 1, wherein
the extractor
extracts the one or more character string regions by applying any one of semantic segmentation, instance segmentation, bounding box detection, and a vision transformer for each of the plurality of directions.

7. The information processing apparatus according to claim 1, wherein
the extractor
for each of the plurality of directions, deforms the image in the direction and extracts the one or more character string regions by using the deformed image.

8. The information processing apparatus according to claim 1, wherein
the determiner
determines the direction for each of the one or more connection regions by applying any one of semantic segmentation, instance segmentation, bounding box detection, and a vision transformer.

9. The information processing apparatus according to claim 1, wherein
the determiner
determines the direction for each of the one or more connection regions by using the image that is enlarged or reduced.

10. The information processing apparatus according to claim 1, wherein
the determiner determines the direction by using a character recognition result for each of the one or more connection regions.

11. The information processing apparatus according to claim 1, wherein
the determiner determines the direction by using a degree of priority for each of the plurality of directions.

12. The information processing apparatus according to claim 1, wherein
the one or more hardware processors are configured to further function as:
an output controller that outputs a display screen for receiving a change of the direction of the selected one or more character string regions to a display, wherein
the selector selects the one or more character string regions extracted in the direction after being changed when the change of the direction is received via the display screen.

13. An information processing method executed by a computer of an information processing apparatus, the method comprising:
extracting, from an image including a plurality of character strings, one or more character string regions including a plurality of character strings written in a direction for each of a plurality of directions;
determining a direction in which a character string included in a connection region is written for each of one or more connection regions, each corresponding to a region in which a plurality of character string regions adjacent to each other is connected; and
selecting, for each of the one or more connection regions, the one or more character string regions extracted in the direction matching the direction determined for the connection region among the one or more character string regions included in the connection region.

14. A computer program product having a non-transitory computer readable medium including instructions stored thereon, wherein the instructions, when executed by a computer, cause the computer to execute:
extracting, from an image including a plurality of character strings, one or more character string regions including a plurality of character strings written in a direction for each of a plurality of directions;
determining a direction in which a character string included in a connection region is written for each of one or more connection regions, each corresponding to a region in which a plurality of character string regions adjacent to each other is connected; and
selecting, for each of the one or more connection regions, the one or more character string regions extracted in the direction matching the direction determined for the connection region among the one or more character string regions included in the connection region.
